(19) United States
(12) Patent Application Publication
(10) Pub. No.: US 2015/0002346 A1
(43) Pub. Date: Jan. 1, 2015

(54) Integrated Printed Decorative Antenna And Electronics

(71) Applicants: Harish Subbaraman, Austin, TX (US); Swapnajit Chakravarty, Austin, TX (US); Yunbo Guo, Austin, TX (US); Ray T. Chen, Austin, TX (US)

(72) Inventors: Harish Subbaraman, Austin, TX (US); Swapnajit Chakravarty, Austin, TX (US); Yunbo Guo, Austin, TX (US); Ray T. Chen, Austin, TX (US)

(73) Assignee: OMEGA OPTICS, INC., Austin, TX (US)

(21) Appl. No.: 14/306,674

(22) Filed: Jun. 17, 2014

Related U.S. Application Data
(60) Provisional application No. 61/841,845, filed on Jul. 1, 2013.

(51) Int. Cl. H01Q 9/04

(52) U.S. Cl. CPC H01Q 9/0407
USPC 343/720

(57) ABSTRACT

Apparatuses comprising an integrated printed decorative image with a printed antenna structure and/or printed electronic circuits are disclosed. In one embodiment, the apparatus comprises a printed decorative image atop the layer of the printed antenna structure, wherein the printed antenna structure is substantially concealed by the printed decorative image. Other embodiments are described and claimed.

### II. CROSS REFERENCE TO RELATED APPLICATIONS

This application claims the benefit of the filing date of U.S. Provisional Patent Application Ser. No. 61/841,845, filed on Jul. 1, 2013, entitled “Integrated Printed Decorative Antenna And Electronics,” the entire disclosure of which is hereby incorporated by reference into the present disclosure.

### I. CROSS REFERENCE TO RELATED APPLICATIONS

This invention was made with government support under contracts N00014-11-C-0704 and NNX09CA37C awarded by the Office of Naval Research (ONR) and National Aeronautics and Space Administration (NASA), respectively. The government has certain rights in the invention.

### III. BACKGROUND

1. Field of the Invention

The present disclosure relates generally to the field of printed decorative antenna and electronics, and more specifically to radiating antenna and electronics integrated as a part of a decorative image printed on a substrate, and various applications of the same.

2. Background of the Invention

The statements in this section merely provide background information related to the present disclosure and may not constitute prior art.

Television antennas are of two types, indoor antennas and outdoor antennas. While popular indoor antenna types include antennas packaged within the television sets or a typical ‘rabbit ear’ type antenna, the outdoor antennas include, but are not limited to Yagi-Uda, parabolic dish etc.

Indoor or outdoor antenna concealed within a painting, signage, mascot, etc. provide dual functionalities as a working antenna element, and as a piece of aesthetic appeal. A picture antenna for television sets is suggested by J. E. Lundy in U.S. Pat. No. 3,261,019 entitled “Picture Antenna For Television Sets” which issued Jul. 12, 1966. The picture antenna consists of a variable antenna containing one loop and two rectangular antennas attached to the back of a picture and incorporated within a picture frame. Different antenna loops are connected to the television set depending upon the position of the pole switches provided at the back.

A picture frame antenna utilizing a thin rigid dielectric circuit board having a circuit printed on it, approximating a dipole antenna, acting as the backing member of the picture frame is suggested by W. E. Neilson in U.S. Pat. No. 3,587,105, entitled “Picture Framed Antenna” which issued Jun. 22, 1971. A television wire antenna serves to position a backing easel to incline the antenna for maximum reception. A further configuration allows the formation of a folded dipole antenna utilizing three circuit boards in three hinged picture frames, with continuous electrical connections through the hinges.

Sadowski et al. in U.S. Pat. No. 8,144,069 entitled “Hidden Wideband Antenna” discloses a compact hidden wideband picture antenna formed by winding the conductive wire into a zigzag pattern to form a bow tie antenna. The bow tie antenna is also hidden inside a decorative household item to improve aesthetic appeal of the home and to provide performance of a wideband antenna for television reception.

Although the dual purpose of aesthetic appeal and functionality are achieved through the above disclosures, the antenna assemblies consist of several discrete parts, which require separate fabrication and packaging processes, resulting in complex integration and increased cost. Additionally, with the above disclosures it is not possible to integrate other electronic devices such as batteries, solar cells, RFID, memories, displays, etc. to provide additional functionalities. Therefore, what is needed in the art is an antenna apparatus that provides aesthetic appeal and functionality as well as integration with other electronic devices such as batteries, solar cells, RFID, memories, displays, etc.

### IV. SUMMARY

A decorative antenna incorporating the functional antenna element integrated together with an artistic image on the same substrate is disclosed. The structure comprises a substrate on which the antenna system together with associated circuitry and the decorative picture is developed, a frame and a backing cover to hold the substrate, a coaxial electrical connector at the back in order to enable connection to a television set or a digital receiver box, and a mounting structure to enable display in a room. The device may further comprise an integrated control circuit consisting of printed electronic components such as transmission lines, photovoltaic cells, batteries, resistors, capacitors, etc.

In one disclosure, the printed broadband antenna is disposed in the same layer as the decorative image, wherein the antenna element also forms a part of the decorative image. The antenna structure comprises a metallic part, and the decorative image comprises coloring materials. The antenna structure is configured to receive the input wireless television signal such that the signal can be transmitted to a television box or a digital receiver via a coaxial electrical connector at the back of the picture frame. The device may further comprise an integrated control circuit consisting of printed electronic components such as transmission lines, photovoltaic cells, batteries, resistors, capacitors, etc.

Moreover, a decorative piece comprising an antenna structure completely concealed by a decorative image is disclosed. In this case, the antenna structure does not form a part of the decorative image, but is a functional antenna element concealed beneath the decorative image on the same substrate material. The antenna structure comprises a metallic single broadband antenna or a metallic antenna array, and the decorative image comprises coloring materials. The antenna structure is configured to receive the input RF wireless signal, such as a television signal, which is fed to the television set via a connector at the back of the frame. The device may further comprise an antenna array control circuit to control the antenna array, an integrated phase shifting network to achieve beam steering, an integrated control circuit consisting of printed electronic components such as transmission lines, active switching elements, photovoltaic cells, batteries, resistors, capacitors, etc. The active switching elements may comprise a field-effect transistor and the field-effect transistor may comprise at least one of: carbon nanotubes, organic semiconductors, graphene, and silicon nanoparticles.

The device may further comprise an antenna array, an integrated phase shifting network, an integrated control circuit, and an integrated power supply in order to achieve beam steering for maximum signal reception.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

To summarize:

The primary objective of the invention is to simplify the fabrication and integration of antenna elements and electronics with a decorative picture by fabricating them on the same substrate using a printing process. For the scope of the present invention, and encompassing all applications resulting from it, the printing technique can refer to any one of solution or vacuum processing techniques. These techniques include, but are not limited to ink jet printing, screen printing, offset printing, gravure printing, contact printing, imprinting, chemical vapor deposition, dip pen printing, etc.

The second objective of the invention is to eliminate the need for external control circuits by utilizing a layer by layer arrangement of decorative image, antenna elements, control circuitry etc. in order to generate a multilayer, multifunctional device that can all be fabricated using the same manufacturing process, thereby greatly simplifying fabrication and integration.

The third objective of the invention is to print a phased array antenna together with the decorative picture in order to achieve beam steering, thereby enabling strong signal reception from other directions, thereby improving signal quality.

The fourth objective is to either conceal by the decorative image or form as part of the decorative image one or more printed electronic components such as sensors, RFIDs, photovoltaic cells, displays, batteries, transmission lines, resistors, capacitors, inductors, transistors, amplifiers, diodes etc.

Other objectives and advantages of the present invention will become apparent from the following descriptions, taken in connection with the accompanying drawings, wherein, by way of illustration and example, an embodiment of the present invention is disclosed.

### V. BRIEF DESCRIPTION OF THE DRAWINGS

The drawings constitute a part of this specification and include exemplary embodiments of the present invention, which may be embodied in various forms. The drawings described herein are for illustrative purposes only of selected embodiments and not of all possible implementations, and are not intended to limit the scope of the present disclosure in any way. It is to be understood that in some instances, various aspects of the present invention may be shown exaggerated or enlarged to facilitate an understanding of the invention.

A more complete and thorough understanding of the present invention and benefits thereof may be acquired by referring to the following description together with the accompanying drawings, in which like reference numbers indicate like features, and wherein:

FIG. 1 is a schematic drawing showing the front view of a decorative antenna device, wherein the antenna element is an integral part of a picture, in accordance with some embodiments.

FIG. 2 is a side view of the decorative antenna device, in accordance with some embodiments.

FIG. 3 is a backside view of the decorative antenna device, in accordance with some embodiments. The picture can either be hung on a wall, or can be left standing on a surface. The electrical connector feeds directly to a television set or a digital television box.

FIG. 4 is a front side, partially transparent view of one embodiment of the decorative antenna, in accordance with some embodiments. The antenna element is on the bottom layer and the picture is on the top layer. The bottom and the top layer are separated by a thin dielectric material.

FIG. 5 is a side view of one embodiment of the decorative antenna, in accordance with some embodiments.

FIG. 6 is a front side, partially transparent view of one embodiment of the decorative antenna, in accordance with some embodiments. An antenna array, together with the control circuit is on the bottom layer, metal interconnections and the driver circuit are in the middle layer, and the decorative picture is on the top layer.

FIG. 7 shows the side view of the device depicted in FIG. 6.

### VI. DETAILED DESCRIPTION

### Detailed Description of the Invention

Detailed descriptions of the preferred embodiments are provided herein. It is to be understood, however, that the present invention may be embodied in various forms. In some instances, there may or may not be a requirement for an antenna, and electronic components can be placed in suitable configurations to form functional, stand-alone devices. Therefore, specific details disclosed herein are not to be interpreted as limiting, but rather as a basis for the claims and as representative basis for teaching one skilled in the art to employ the present invention in virtually any appropriately detailed system, structure, or manner. This section will provide detailed description of the preferred embodiments in the aspect of device architecture, as well as the design concept. Example embodiments will now be described fully with reference to the accompanying drawings.

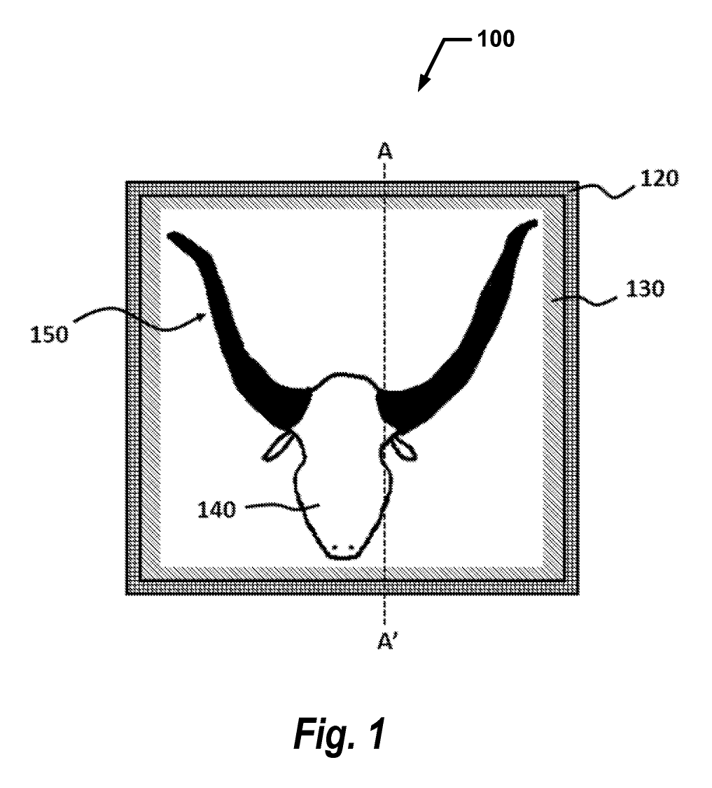

Referring initially to FIG. 1, a decorative antenna device 100 with an integrated antenna is schematically illustrated. Generally, the decorative antenna structure 100 includes a picture frame 120 made of wood, aluminum, plastic etc., a substrate material 130 (e.g. paper, cardboard, wood, plastic etc.), and a decorative picture 140 fabricated directly on the substrate 130. The decorative picture 140 is fabricated using printing techniques and is made of colored pigments to provide aesthetic appeal. A portion of the decorative picture is intentionally printed using metal nanoparticle inks such as silver, gold, and/or copper, etc. in order to form the television antenna 150.

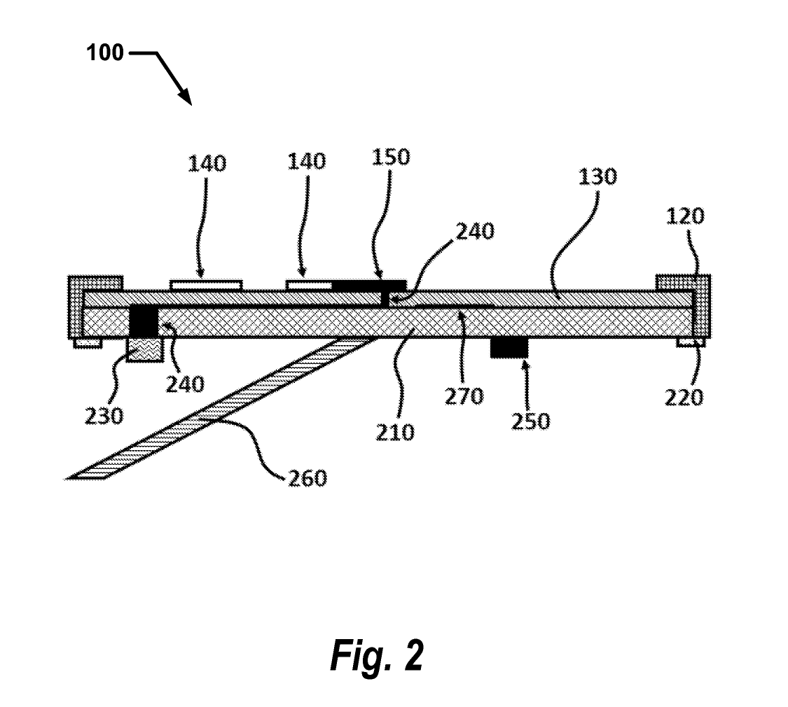

FIG. 2 shows a side view cross section of the decorative antenna device 100 along the line A-A′ of FIG. 1. The decorative image 140, along with the antenna element 150, are printed on the same substrate 130. The frame 120, together with the backing plane 210 and securing clips 220 hold the substrate 130 intact within the frame 120. A coaxial electrical connector 230 feeds the television signal received by the antenna element 150 either directly to a television set or a digital receiver. The signal received by the antenna element 150 is routed to the coaxial electrical connector 230 via metal interconnects 240 that are formed by directly making holes in the layers 130 and 210 and filling the holes with the metal ink. The decorative picture may be mounted directly on a wall via a mount 250 on the back, or may be mounted on the television set via a stand 260. Some embodiments of the decorative antenna device 100 may also contain a metal ground plane 270 printed on the back of the substrate 130 for some specific types of antennas.

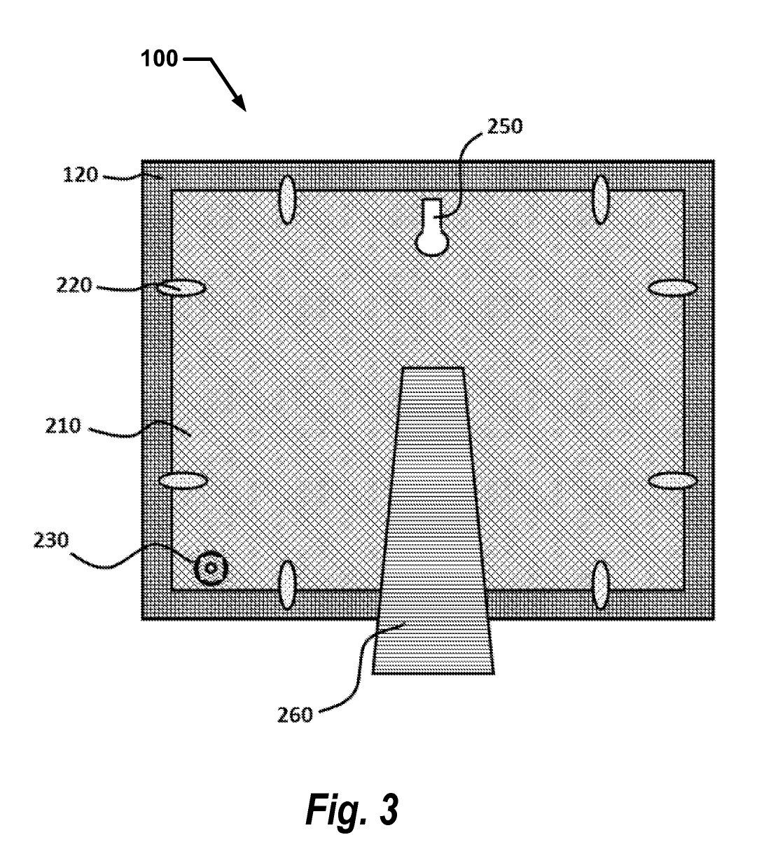

FIG. 3 is a schematic showing the backside of the decorative antenna device 100. The frame 120 together with a backing plane 210 and securing clips 220, hold the decorative picture substrate 130 of FIGS. 1 and 2 in place. The backing plane 210 can be made of wood, plastic, metal, cardboard etc. A mounting hook 250 may be used to mount the picture to the wall, or a stand 260 may be used to place the decorative picture directly on top of the television set. The coaxial electrical connector 230 is used to feed the television transmission signal received by the antenna to a television set via a coaxial cable.

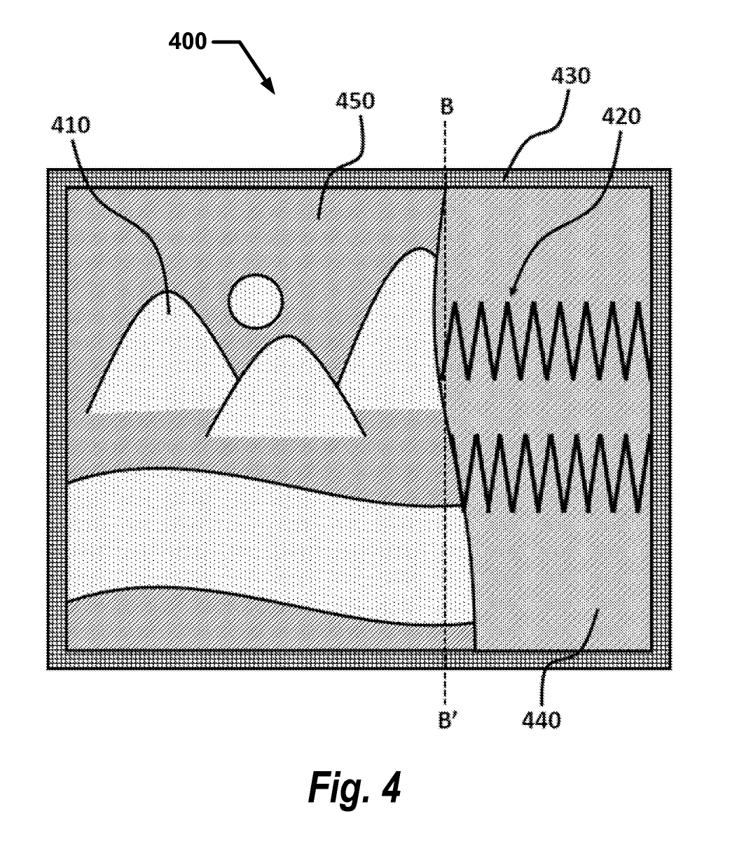

In another embodiment of the present invention, shown in FIG. 4, the decorative antenna device 400 may comprise a decorative picture 410 and an antenna element 420 on separate layers within a frame 430. The antenna element 420 comprises metal nanoparticles such as silver or copper nanoparticles printed on top of the substrate material 440 such as paper, plastic, wood, etc. For certain antenna designs, a ground plane is printed directly on the backside of the substrate 440. The decorative picture 410 is printed on top of another dielectric material layer 450 which is printed on top of the antenna structure 420, thereby completely concealing the antenna from outside view. An advantage of the disclosed structure compared to the prior art described by Lundy's U.S. Pat. No. 3,261,019 and Sadowski's U.S. Pat. No. 8,144,069 is that the antenna structure and the decorative picture can be developed using a single printing process, which greatly simplifies the integration and production efforts.

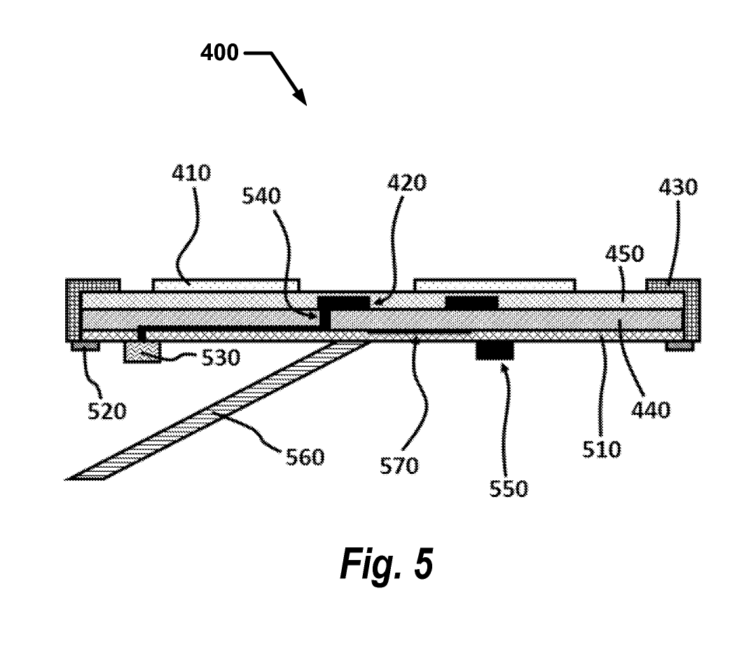

FIG. 5 shows a side view cross section of the decorative antenna device 400 along the line B-B′ of FIG. 4. The decorative image 410 and the antenna element 420 are printed on the two dielectric layers 450 and 440, respectively. The frame 430, together with the backing plane 510 and securing clips 520 hold the substrate 440 intact within the frame 430. A coaxial electrical connector 530 feeds the television signal received by the antenna element 420 either directly to the television set or a digital receiver. The signal received by the antenna element 420 is routed to the coaxial electrical connector 530 via metal interconnects 540 that are formed by directly making holes in the layers 440 and 450 and filling the holes with the metal ink. The decorative picture can be mounted directly on a wall via a mount 550 on the back, or can be mounted on top of the television set via a stand 560. Some embodiments of the decorative antenna device 400 may also contain a metal ground plane 570 printed on the back of the substrate 440 for some specific types of antennas.

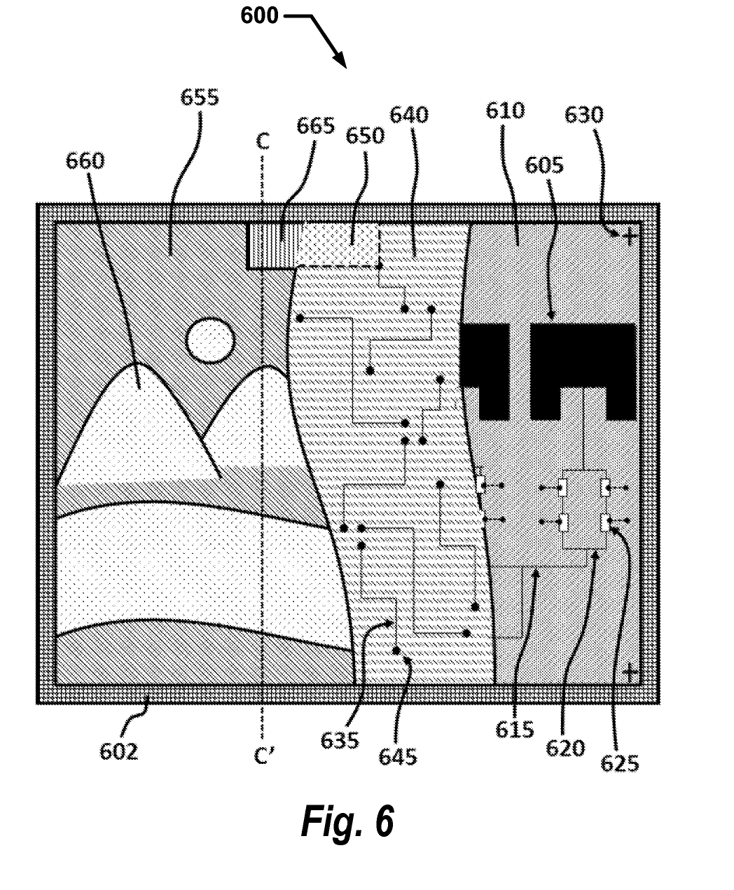

Referring to FIG. 6, in some embodiments, the decorative antenna 600 utilizes a phased array antenna structure within the entire frame 602 in order to enable beam steering and improved signal reception. The 1-D or 2-D antenna array elements 605 comprise metal nanoparticles such as silver or copper nanoparticles printed on top of the substrate material 610 such as paper, plastic, wood, etc. For certain antenna designs, a ground plane is printed directly on the backside of the substrate 610. The antenna array control circuitry comprises metal transmission lines 615 and phase shifting networks 620 printed on top of the same substrate 610. The phase shifting networks 620 further comprise several arms, each with active switching elements 625 whose ON/OFF states control the signal delay, and hence its phase. The switching elements 625 comprise field-effect transistors either fabricated in a bottom gate or a top gate configuration. The field-effect transistors may comprise carbon nanotubes, organic semiconductors, silicon nanoparticles etc. in the active channel layer. Printed metal nanoparticles form the gate, source, and drain regions. The dielectric may comprise any printable dielectric material. In order to form the field-effect transistors comprising the above mentioned layers, alignment marks 630 printed on the substrate 610 are employed to achieve accurate alignment between the different material layers. Referring again to FIG. 6, the metal interconnections 635 are printed on top of another dielectric material layer 640 which is printed on top of the antenna array structures 605, thereby completely concealing the antenna array from outside view. The metal interconnects 635 are connected to the phase shifting networks 620 through metal via interconnects 645. A photovoltaic cell 650 may also be printed on the same layer 640 in order to provide power for the circuitry and electronics. Another dielectric layer 655 is printed on top of the dielectric layer 640 containing the metal interconnections 635 and photovoltaic cell 650. The decorative image 660 is printed on top of the dielectric layer 655, thereby also concealing the metal interconnects 635. If the photovoltaic cell 650 is printed as a part of the device, a transparent window 665 within the dielectric layer 655 may be left directly over the photovoltaic cell.

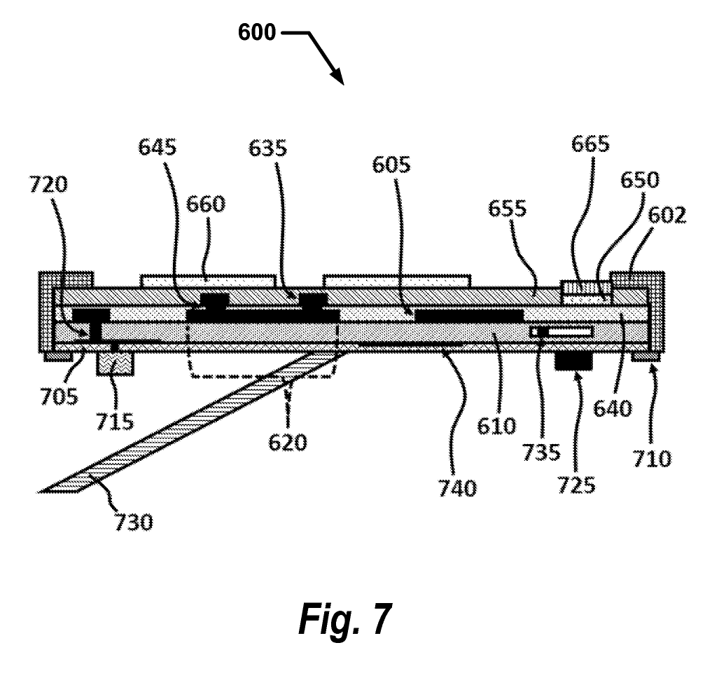

FIG. 7 shows a side view cross section of the decorative antenna device 600 along the line C-C′ of FIG. 6. The antenna array elements 605 and the control networks 620 are printed on the substrate layer 610. Another dielectric layer 640 is printed on top of the substrate 610 containing the antenna array 605 and control networks 620. Via holes 645 are formed in the layer 640 and silver metal interconnects 635 are formed on top of layer 640 such that the metal ink fills the via holes 645 and connects the control network 620 with the interconnects 635. If self powering is required, a photovoltaic cell 650 is also printed on top of layer 640. Another dielectric layer 655 is then printed on top of the structure, and a transparent window 665 comprising a transparent dielectric is also printed over the photovoltaic cell 650. The decorative image 660 is then printed on top of layer 655. The frame 602, together with the backing plane 705 and securing clips 710 hold the substrate 610 intact within the frame 602. A coaxial electrical connector 715 feeds the television signal received by the antenna array 605 either directly to the television set or to a digital receiver. The signal received by the antenna array 605 is routed to the coaxial electrical connector 715 via metal interconnects 720 that are formed by directly making holes in the layers 610 and 705 and filling the holes with the metal ink. The decorative antenna device 600 can be mounted directly on a wall via a mount 725 on the back, or can be mounted on top of the television set via a stand 730. The ON/OFF switching configuration of the different switches in the phase control networks may be controlled using an external knob 735, thereby enabling beam steering for better signal reception. Some embodiments of the decorative antenna device 600 may also contain a metal ground plane 740 printed on the back of the substrate 610 for some specific types of antennas.

Although the device described herein is for television signal reception, one skilled in the art will understand that the structure in its general form may include sensors, radio-frequency identification, batteries, photovoltaic cells, displays, transistors, resistors, capacitors, inductors, diodes, etc. in addition to antenna systems or maybe be included as stand-alone devices.

In summary, the present invention provides a decorative picture antenna together with electronic components for television signal reception developed using single and multi layer printing. The invention enables development of the decorative antenna, with a great relief in fabrication and integration efforts due to its realization in a single printing process, thereby maximizing the product yield. The invention also enables the realization of several other decorative picture circuits that may contain printed electronics as a part of the image, or as a concealment, that provide additional capabilities to the decorative image apart from aesthetic appeal alone. Owing to the solution and vacuum based printing processes used for developing the decorative antenna structure presented herein, one can integrate several other printable devices such as RFID, solar cells etc. on the same substrate.

While the invention has been described in connection with a number of preferred embodiments, it is not intended to limit the scope of the invention to the particular form set forth, but on the contrary, it is intended to cover such alternatives, modifications, and equivalents as may be included within the design concept of the invention as defined by the appended claims.

1. An integrated decorative apparatus comprising:
a substrate;
a printed antenna structure atop the substrate;
a printed decorative image atop the substrate, wherein the printed decorative image is within the layer of the printed antenna structure, above the layer of the printed antenna structure, and/or below the layer of the printed antenna structure; and
printed electronic circuits, wherein the printed electronic circuits are within the layer of the printed antenna structure, above the layer of the printed antenna structure, and/or below the layer of the printed antenna structure;
wherein the printed electronic circuits are substantially concealed by the printed decorative image; and
wherein the printed antenna structure is substantially concealed by the printed decorative image.

2. The integrated decorative apparatus of claim 1, wherein the printed antenna structure comprises a portion of the printed decorative image.

3. The integrated decorative picture of claim 1, wherein the printed electronic control circuits are unique.

4. The integrated decorative apparatus of claim 1, wherein the substrate comprises paper, cardboard, plastic, and/or glass.

5. The integrated decorative apparatus of claim 1, wherein the printed antenna structure material comprises nanoparticle silver, gold, and/or copper.

6. The integrated decorative picture of claim 1, wherein the printed decorative image comprises colored ink pigments.

7. The integrated decorative apparatus of claim 1, wherein the printed antenna structure comprises a single broadband antenna or an antenna array.

8. The integrated decorative apparatus of claim 7, further comprising a printed antenna array control circuit configured to control the antenna array.

9. The integrated decorative apparatus of claim 8, wherein the printed antenna array control circuit comprises printed metal conductive transmission lines and printed active switching elements.

10. The integrated decorative apparatus of claim 9, wherein the printed active switching elements comprise a field-effect transistor.

11. The integrated decorative apparatus of claim 10, wherein the field-effect transistor comprises at least one of: carbon nanotubes, organic semiconductors, graphene, and silicon nanoparticles.

12. The integrated decorative apparatus of claim 1, further comprising a printed ground plane on the substrate on the side opposite the printed antenna structure.

13. The integrated decorative apparatus of claim 1, wherein the printed electronic control circuits comprise at least one of a photovoltaic cell, a battery, a memory, a transistor, a phase shifter, an interconnection line, and a transmission line.

14. An integrated decorative apparatus comprising:
a substrate;
printed electronic circuits atop the substrate; and
a printed decorative image printed atop the substrate, wherein the printed decorative image is within the layer of the printed electronic circuits, above the layer of the printed electronic circuits, and/or below the layer of the printed electronic circuits;
wherein the printed electronic circuits are substantially concealed by the printed decorative image.

15. The integrated decorative picture of claim 14, wherein the printed electronic control circuits are unique.

16. The integrated decorative apparatus of claim 14, wherein the substrate comprises paper, cardboard, plastic, and/or glass.

17. The integrated decorative picture of claim 14, wherein the printed decorative image comprises colored ink pigments.

18. The integrated decorative apparatus of claim 14, further comprising a ground plane printed on the substrate on the side opposite the printed electronic circuits.

19. The integrated decorative apparatus of claim 14, wherein the printed electronic control circuits comprise at least one of a photovoltaic cell, a battery, a memory, a transistor, a phase shifter, an interconnection line, and a transmission line.

20. An integrated decorative antenna comprising:
a substrate;
a printed antenna structure atop the substrate;
a printed phase control network atop the substrate;
a first dielectric atop the substrate, atop the printed antenna, and atop the printed phase control network;
one or more printed interconnects atop the first dielectric;
one or more via holes through the first dielectric, wherein the one or more via holes are filled with metal ink and are configured to electrically connect the one or more printed interconnects to the printed phase control network;
a control knob electrically connected to the printed phase control network, wherein the control knob is configured to allow control of the printed phase control network to enable beam steering for adjustment of signal reception;
a second dielectric atop the one or more printed interconnects and atop the first dielectric; and
a printed decorative image atop the second dielectric.
